(19) United States
(12) Patent Application Publication
(10) Pub. No.: US 2014/0210371 A1
(43) Pub. Date: Jul. 31, 2014

(54) DIGITALLY CONTROLLED ELECTRONIC BALLAST WITH ANTI-STRIATION CONTROL AND METHOD OF OPERATION THEREOF

(71) Applicants: William Lawrence Keith, Lake in The Hills, IL (US); George Gruev, Lake Zurich, IL (US)

(72) Inventors: William Lawrence Keith, Lake in The Hills, IL (US); George Gruev, Lake Zurich, IL (US)

(73) Assignee: KONINKLIJKE PHILIPS N.V., EINDHOVEN (NL)

(21) Appl. No.: 14/241,729

(22) PCT Filed: Sep. 10, 2012
(86) PCT No.: PCT/IB2012/054682

§ 371 Date: Feb. 27, 2014

Related U.S. Application Data
(60) Provisional application No. 61/534,522, filed on Sep. 14, 2011.

(51) Int. Cl. H05B 41/16; H05B 41/36

(52) U.S. Cl. CPC H05B 41/16; H05B 41/36
USPC 315/287

(57) ABSTRACT

An apparatus to supply power to at least one gas lamp, the apparatus including a half bridge driver having a striation control circuit which determines an on time (Ton) for a cycle in accordance with a fifty percent duty cycle, the cycle having a plurality of segments and lasting for a predetermined period of time and modulates on times Ton1 and Ton2 of first and second power switches, respectively, of a half-bridge circuit in accordance with a striation control technique for each of the plurality of segments.

The present system relates to a digitally controlled electronic ballast to drive fluorescent lamps and, more particularly, to a digitally controlled dimmable electronic ballast with a striation function to reduce or eliminate striations when driving fluorescent lamps and a method of operation thereof.

Under certain conditions of operation, a fluorescent lamp or the like (hereinafter lamp) can produce striations. Striations are manifested as visible bands of alternating bright and dim areas in a lamp that sometimes move across a portion or entire length of the lamp and can appear in standard lamps as well as the new energy savings lamps. Striations can be stationary or can move at different speeds across the lamp and, thus, can appear to a viewer as a standing wave.

The likelihood of gas lamp forming lighting striations can be predicted based upon a physical structure of the lamp. For example, many new energy saving lamps contain a heavy fill gas such as Krypton which can increase the likelihood of forming striations especially when operating a lamp at low operating temperatures. Further, operating a ballast in a dimming mode so as to drive a fluorescent lamp at low current levels used to dim the lamp can increase the likelihood of forming striations under certain operating conditions.

Accordingly, it would be desirable to improve upon conventional ballast driving circuits to control an output of the ballast to a load such as a fluorescent lamp so as to control, reduce, or prevent the formation of striations.

The present system discloses a system, method, circuit, apparatus, and computer program portion (hereinafter each of which may be referred to as system unless the context indicates otherwise) which is configured to control a ballast which drives a fluorescent lamp so as to control, reduce, and/or prevent striations under various operating conditions (e.g., cold, normal, over temperature, various temperature ranges, fault, etc.) and at various operating settings (e.g., dimming, bright, start, etc.).

In accordance with an aspect of the present system, there is disclosed an apparatus to drive a switching half-bridge circuit to supply power to a load including at least one gas lamp (e.g., a linear fluorescent lamp). The apparatus may include a half bridge driver which provides control signals to drive first and second power switches of the half-bridge circuit at substantially a 50% duty cycle with a corresponding Ton during a first mode of operation such that Ton1 and Ton2 of the first and second switches, respectively, are substantially equal to Ton during a cycle; and a striation control circuit which determines whether to operate in a striation control mode (SCM) and sets Ton1 and Ton2 in accordance with a striation control setting when it is determined to operate in the SCM. Further, the striation control circuit may set Ton1 and Ton2 differently from each other within a given segment and to Ton for a plurality of segments within the cycle when it is determined to operate in the SCM. Moreover, the striation control circuit may sets Ton1 and Ton2 in accordance with a predetermined striation control pattern when operating in the SCM. Moreover, the striation control circuit may set Ton1 and Ton2 in accordance with the following equations for a plurality of segments (i) within the cycle:

Ton1(i)=Ton+kx(i), and

Ton2(i)=Ton−kx(i),

wherein Ton may be set to regulate a current supplied to the load in accordance with the 50% duty cycle, k is a constant, and x(i) varies in accordance with each segment (i).

Further, it is envisioned that the striation control circuit may determine whether a last segment (i) of the plurality of segments has been completed and may repeat one or more of the plurality of segments from the first segment of the plurality of segments until it is determined that the cycle is completed.

It is also envisioned that the striation control circuit may determine whether striations are present in an output of the at least one gas lamp, and operate in the SCM when it is determined that striations are present in the output of the at least one gas lamp. Moreover, the striation control circuit may determine whether to operate in the SCM based upon one or more of a dimming setting and a temperature of the at least one lamps.

In accordance with a further aspect of the present system, there is disclosed an apparatus to supply power to at least one gas lamp, the apparatus may include a half bridge driver having a striation control circuit which determines an on time (Ton) for a cycle in accordance with a fifty percent duty cycle, the cycle having a plurality of segments and lasting for a predetermined period of time; and/or modulates on times Ton1 and Ton2 of first and second power switches, respectively, of a half-bridge circuit in accordance with a striation control technique for each of the plurality of segments. The apparatus may further generate first and second control signals for driving the first and second power switches, respectively, in accordance with Ton1 and Ton2, respectively.

In accordance with yet another aspect of the present system, there is disclosed a method to control a switching half-bridge circuit to supply power to a load, the method may include one or more acts which are performed by a processor. The acts may include: providing control signals to drive first and second power switches of the half-bridge circuit at substantially a 50% duty cycle with a corresponding Ton during a first mode of operation such that Ton1 and Ton2 of the first and second switches, respectively, are substantially equal to Ton during a cycle; determining whether to operate in a striation control mode (SCM); and/or setting Ton1 and Ton2 in accordance with an SCM technique when it is determined to operate in the striation control mode. The method may further include an act of setting Ton1 and Ton2 differently from each other within a given segment and to Ton for a plurality of segments within the cycle when it is determined to operate in the SCM. Moreover, the method may include an act of setting Ton1 and Ton2 in accordance with a predetermined striation control pattern when operating in the SCM. Further, the method may include an act of setting Ton1 and Ton2 in accordance with the following equations for a plurality of segments (i) within the cycle:

Ton1(i)=Ton+kx(i), and

Ton2(i)=Ton−kx(i),

wherein Ton is set to regulate a current supplied to the load in accordance with the 50% duty cycle, k is a constant, and x(i) varies in accordance with each segment (i).

It is also envisioned that the method may include acts of: determining whether a last segment (i) of the plurality of segments has been completed; and/or repeating one or more of the plurality of segments from the first segment of the plurality of segments until it is determined that the cycle is completed.

Moreover, it is envisioned that the method may include one or more acts of: determining whether striations are present in an output of the at least one gas lamp; and operating in the SCM when it is determined that striations are present in the output of the at least one gas lamp. Further, the method may include an act of determining whether to operate in the SCM based upon one or more of a dimming setting and/or a temperature of the at least one lamps. In accordance with a further aspect of the present system, there is disclosed a method to control a switching half-bridge circuit to supply power to a load, the method may include one or more acts which are performed by a processor, the acts including acts of: determining an on time (Ton) for a cycle in accordance with a fifty percent duty cycle, the cycle having a plurality of segments and lasting for a predetermined period of time; and/or modulating on times Ton1 and Ton2 of first and second power switches, respectively, of a half-bridge circuit in accordance with a striation control technique for each of the plurality of segments. The method may further include acts of generating first and second control signals for driving the first and second power switches, respectively, in accordance with Ton1 and Ton2, respectively.

In accordance with yet a further aspect of the present system, there is disclosed a computer program stored on a computer readable non-transitory memory medium, the computer program is configured to control a switching half-bridge circuit to supply power to a load, the computer program may include a program portion configured to generate control signals to drive first and second power switches of the half-bridge circuit at substantially a 50% duty cycle with a corresponding Ton during a first mode of operation such that Ton1 and Ton2 of the first and second switches, respectively, are substantially equal to Ton during a cycle; determine whether to operate in a striation control mode (SCM); and set Ton1 and Ton2 in accordance with an SCM technique when it is determined to operate in the striation control mode. The computer program portion may be further configured to set Ton1 and Ton2 differently from each other within a given segment and to Ton for a plurality of segments within the cycle when it is determined to operate in the SCM. Moreover, the program portion may be further configured to set Ton1 and Ton2 in accordance with a predetermined striation control pattern when operating in the SCM. Further, the program portion may be further configured to set Ton1 and Ton2 in accordance with the following equations for a plurality of segments (i) within the cycle:

Ton1(i)=Ton+kx(i), and

Ton2(i)=Ton−kx(i),

wherein Ton is set to regulate a current supplied to the load in accordance with the 50% duty cycle, k is a constant, and x(i) varies in accordance with each segment (i).

In accordance with yet a further aspect of the present system, there is disclosed a computer program stored on a computer readable non-transitory memory medium, the computer program configured to at least one gas lamp, the computer program may include a program portion configured to: determine an on time (Ton) for a cycle in accordance with a fifty percent duty cycle, the cycle having a plurality of segments and lasting for a predetermined period of time; and modulate on times Ton1 and Ton2 of first and second power switches, respectively, of a half-bridge circuit in accordance with a striation control technique for each of the plurality of segments; and/or generate first and second control signals for driving the first and second power switches, respectively, in accordance with Ton1 and Ton2, respectively.

The invention is explained in further detail, and by way of example, with reference to the accompanying drawings wherein:

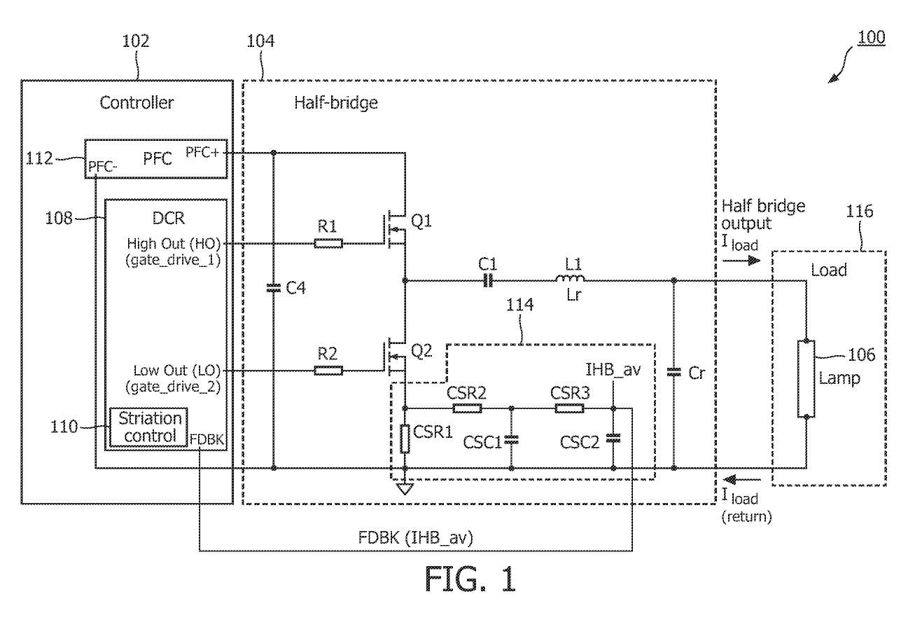

FIG. 1 is a schematic of a ballast circuit 100 powering a load which includes a lamp 106 in accordance with embodiments of the present system;

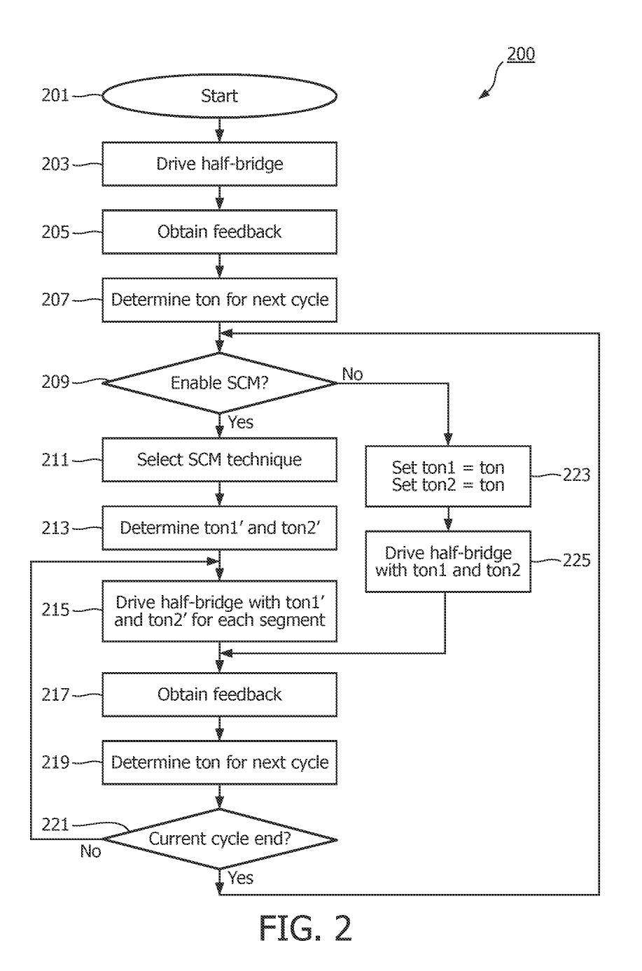

FIG. 2 shows a flow diagram that illustrates a process in accordance with embodiments of the present system;

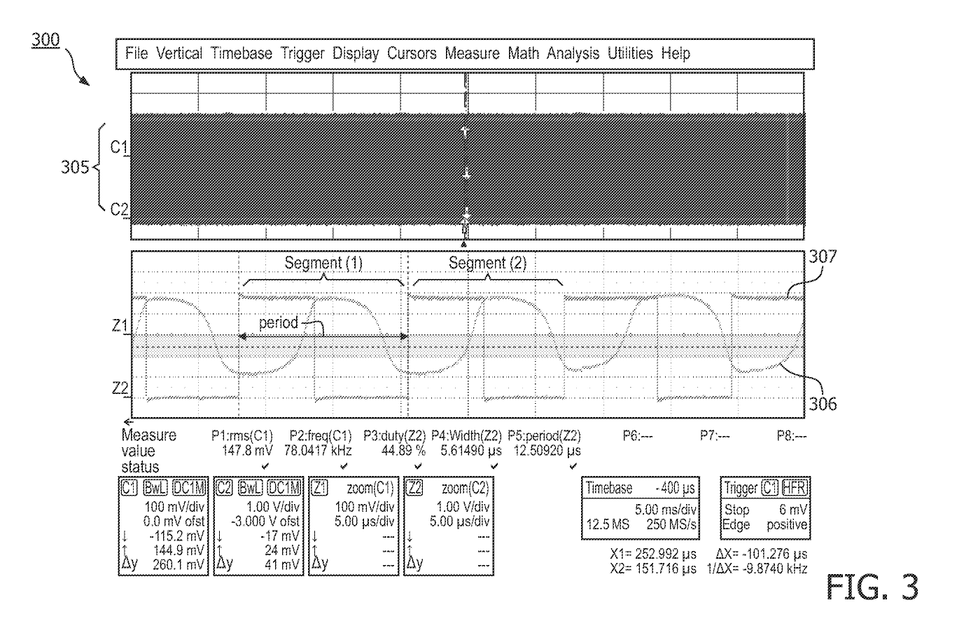

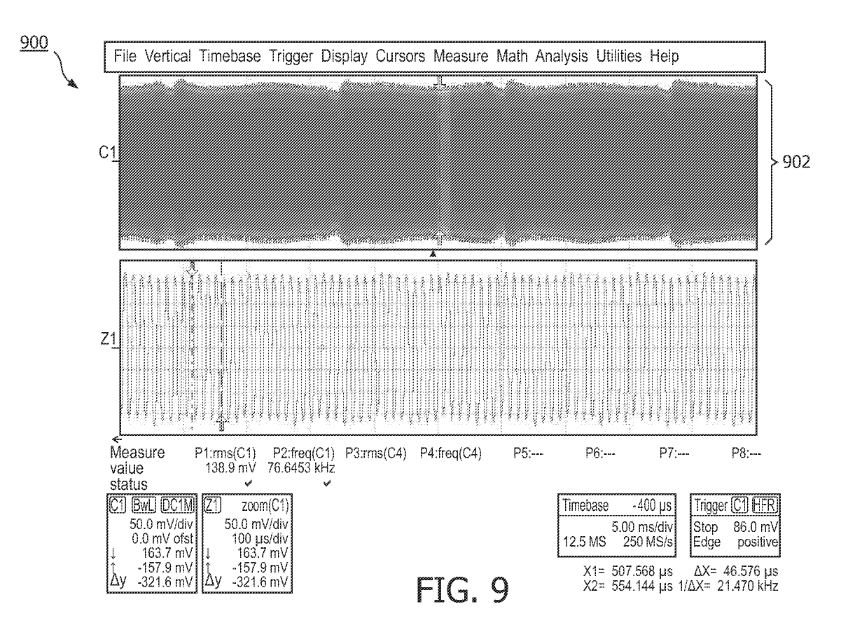

FIG. 3 is a screenshot of a graph 300 illustrating a pulse width modulation (PWM) output from a controller to a half bridge driver for generating the current envelope shown in FIG. 9 in accordance with embodiments of the present system;

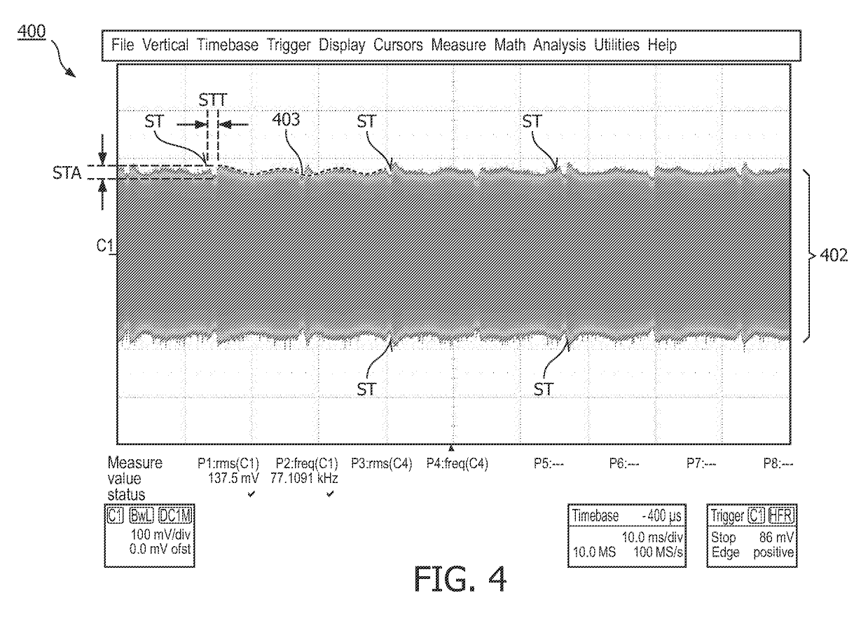

FIG. 4 is a graph illustrating a lamp current envelope without anti-striation modulation;

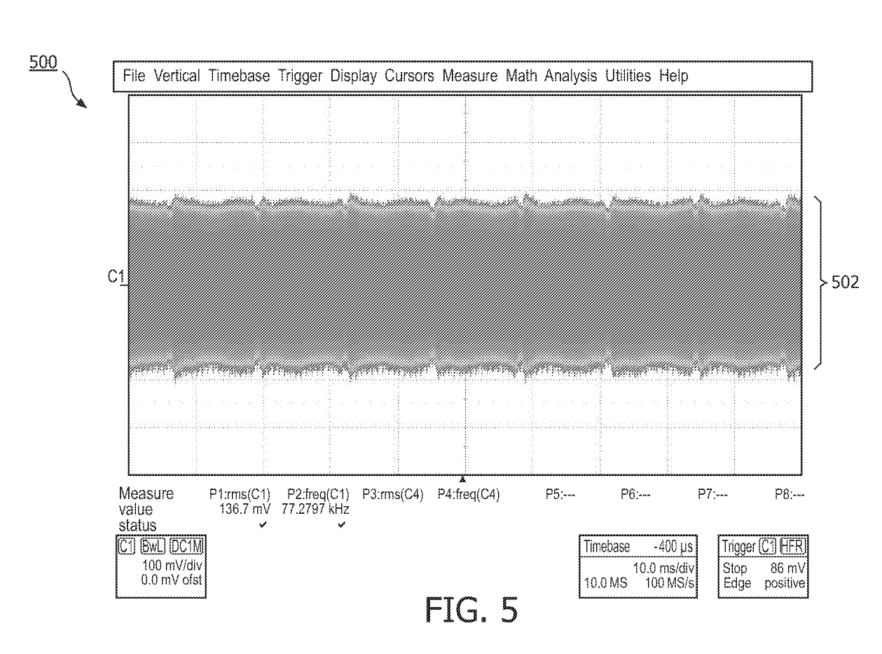

FIG. 5 is a screenshot of a graph illustrating lamp current envelope with striation control modulation (SCM) in accordance with embodiments of the present system;

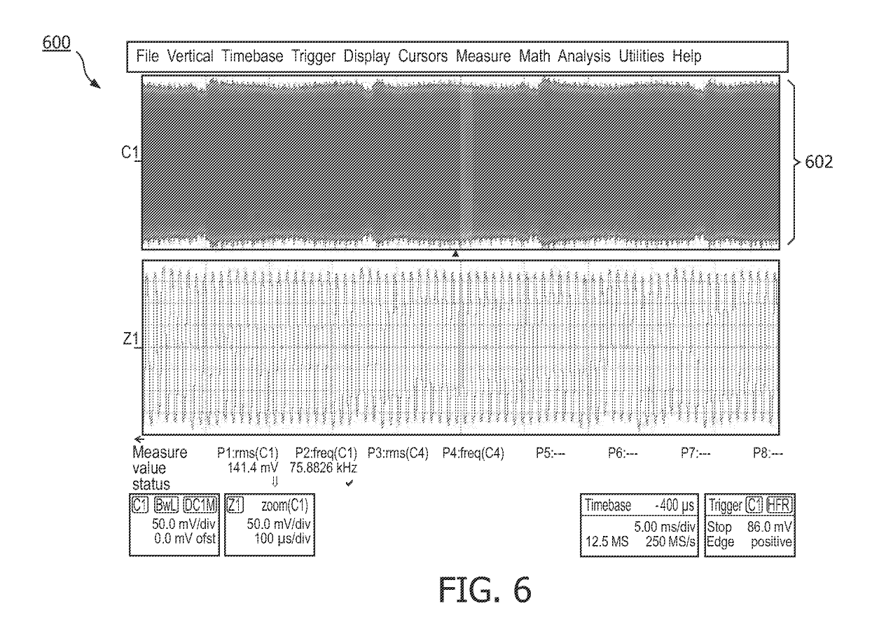

FIG. 6 is a screenshot of a graph illustrating lamp current envelope with striation control modulation (SCM) in accordance with embodiments of the present system;

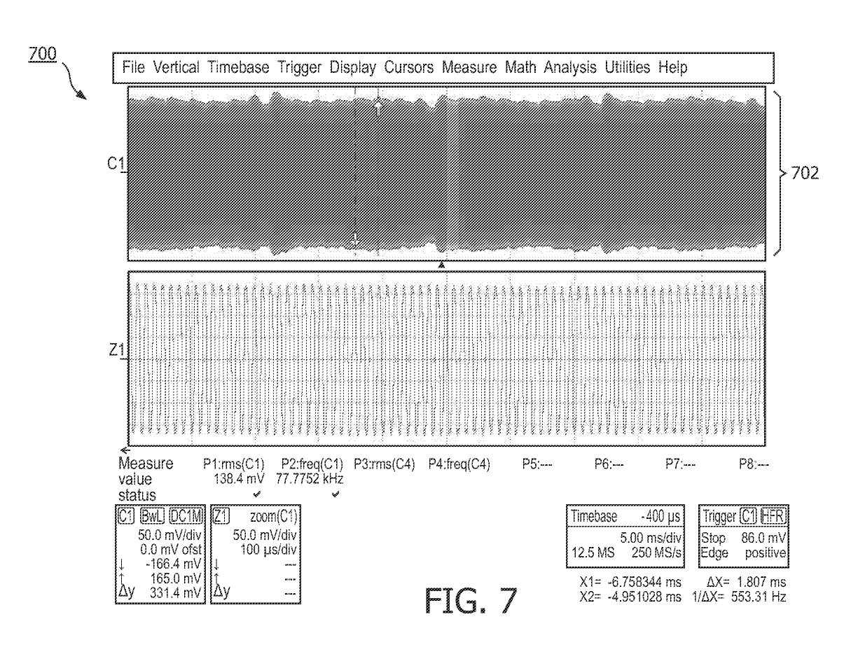

FIG. 7 is a screenshot of a graph illustrating lamp current envelope with striation control modulation (SCM) in accordance with embodiments of the present system;

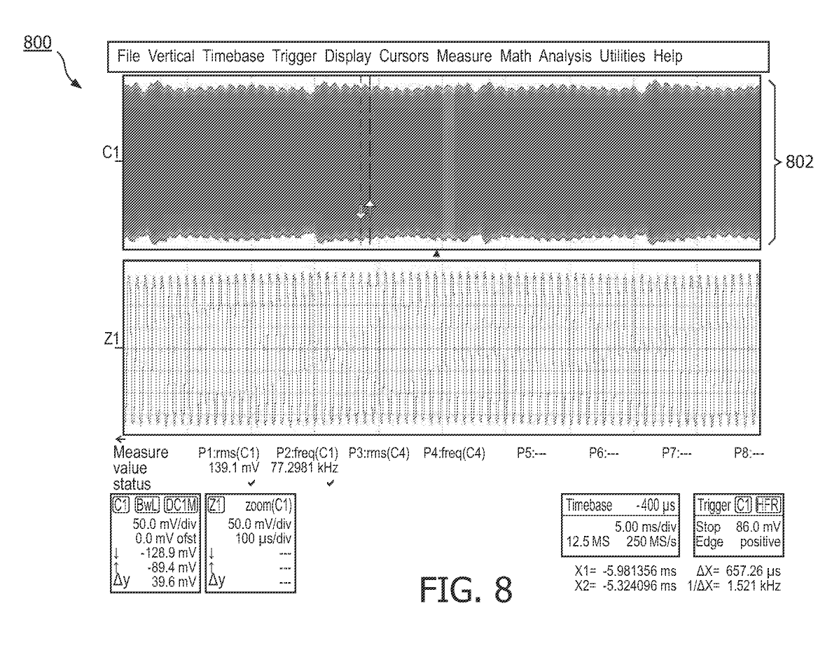

FIG. 8 is a screenshot of a graph illustrating lamp current envelope with striation control modulation (SCM) in accordance with embodiments of the present system;

FIG. 9 is a screenshot of a graph illustrating lamp current envelope with striation control modulation (SCM) in accordance with embodiments of the present system; and

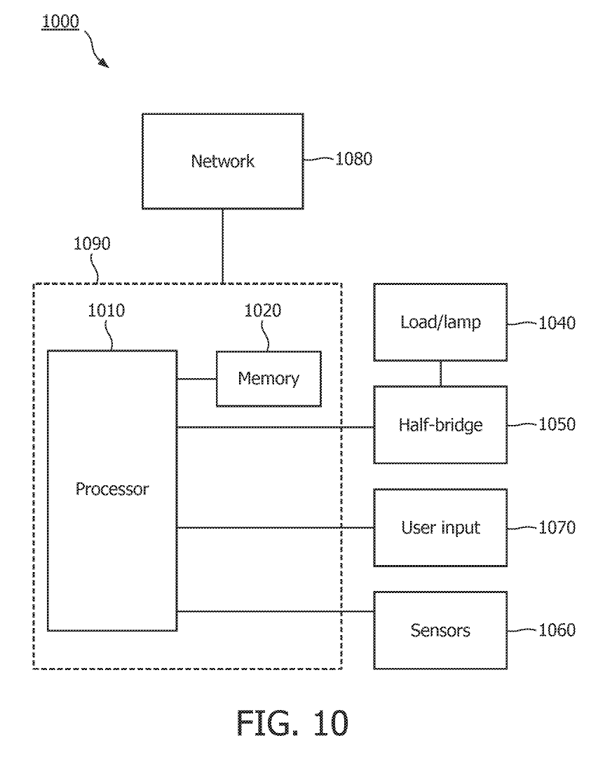

FIG. 10 shows a portion of a system in accordance with embodiments of the present system.

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well-known devices, circuits, tools, techniques, and methods are omitted so as not to obscure the description of the present system. It should be expressly understood that the drawings are included for illustrative purposes and do not represent the scope of the present system. In the accompanying drawings, like reference numbers in different drawings may designate similar elements.

FIG. 1 is a schematic of a ballast circuit 100 powering a load 116 which includes a lamp 106 in accordance with embodiments of the present system. The ballast circuit 100 may employ digital control of an output stage and may include one or more of a controller 102 (e.g., microprocessor) which controls operation of an output stage such as a half bridge circuit 104 which drives the load 116.

The load 116 may include any suitable load circuit such one or more lamps 106. The one or more lamps 106 may include one or more gas lamps such as fluorescent lamps (e.g., such as linear fluorescent lamps (LFLs), compact fluorescent lamps (CFL), or the like).

The half bridge circuit 104 may include high and low gates Q1 and Q2, respectively, and may drive the load 116 so as to deliver power to the load 116 and, thus, to the one or more lamps 106. The high and low gates Q1 and Q2, respectively, may include any suitable power switches such as transistor switches (e.g., power MOS such as MOSFETS, etc.). In operation, the load (lamp) looks like a resistor and has a negative impedance characteristic. Lamp voltage increases as lamp current is reduced. The lamp is ignited by running near the unloaded resonance frequency of Lr and Cr (CL has a minimal effect on the resonance frequency because it is usually chosen to be very large compared to Cr). In this way, a high voltage is generated to ignite the lamp. After ignition the load (lamp) is driven at a given frequency to regulate the current through it.

A current shunt resistor circuit 114 may be situated along a load return path (e.g., load return) which may be associated with Q2 so as to regulate a half bridge output current (I_{LOAD}) of the half bridge 104 at least in part. The current shunt resistor circuit 114 may include capacitors CSC1 and CSC2 and resistors CSR1 through CSR3 and may generate a feedback (FDBK) signal such as IHB_av which may provide information related to current flowing through the load 116 (e.g. I_{LOAD}) and thus, information related to a lamp current (I_{LC}) flowing in one or more lamps 106.

The current shunt resistor circuit 114 may provide a voltage signal (e.g., the FDBK signal IHB_av) that is proportional to the half bridge output current (I_{LOAD}). Because the half bridge 104 is fed with a constant voltage from the PFC 112 this signal (e.g., the FDBK signal IHB_av) is also proportional to half bridge power. Since the losses are known for the half bridge 104, lamp power (of the one or more lamps 106) may be calculated by subtracting the losses from the half bridge power. However, it is also envisioned that other methods may be used to obtain lamp power. The current shunt resistor circuit 114 being just one illustrative method. Other methods may include a shunt resistor in series with the load, a current transformer, etc. Regulating lamp power may be necessary when dimming to maintain a constant illumination level from the one or more lamps 106, especially at low dim levels. However, it should be understood that a current feedback circuit may not be necessary in all embodiments such as an embodiment wherein the lamp is not dimmable. However, when using a dimming ballast, a current feedback circuit may be desirable to control the half bridge 104 when dimming to maintain a constant illumination level from the one or more lamps 106. Further, embodiments of the present system may be compatible with non-dimming ballasts with or without any feedback such as current feedback to monitor lamp current. However, in embodiments of the present system, feedback such as current feedback may be used to regulate (lamp) power/current by changing the frequency of the ballast as will be discussed herein.

The controller 102 may control the overall operation of the ballast circuit 100 and may operate under control of one or more processors (e.g., a microprocessor, a logic device, an analog or digital logic circuit, etc.) and may include a digital control regulator (DCR) 108 which may operate under the control of the one or more processors. The Controller (e.g., DCR, etc.) may include analog or digital circuits to generate the first and second drive signals. The controller 102 may be configured to control (e.g., the controller such as the DCR, PFC, etc., may include analog and/or digital circuits such as to generate first and second drive signals) an output stage such as the half bridge circuit 104 and may include a power factor correction (PFC) pre-conditioner 112 which may supply a regulated direct current (DC) voltage (e.g., PFC+ and PFC−) to the half bridge circuit 104 at a desired voltage. The controller 102 may also receive control signals from a user or the system such as on/off settings, dimming setting, etc. The control signals (e.g., on/off dimming level, etc.) may be generated by a control circuit (e.g., a dimming switch, an on/off wall switch, etc.), an automated controller (e.g., a digital addressable lighting interface (DALI) controller)), etc. The control signals may be received over a wired and/or wireless network such as, an analog network, a proprietary network, a local or wide area network (LAN, WAN), a DALI network, and/or over other wired/wireless connection in accordance with embodiments of the present system.

The DCR 108 may utilize a switching on-time provided to the load 116 through the half bridge 114 by controlling operating frequency and/or power output provided to the half bridge 104 and consequently control the power output provided to the load 116 by the half bridge 104. Accordingly, the DCR 108 may be operative to drive the high and low gates Q1 and Q2, respectively, of the half bridge 104 so as to control power output of the half bridge 104 and, thus, regulate power output of the one or more lamps 106. To drive the first and second gates (Q1 and Q2, respectively), the process may generate a first drive signal (e.g., Gate_Drive_1) to drive the first gate (e.g., Q1) and generate a second drive signal (e.g., Gate_Drive_2) to drive the second gate (e.g., Q2). The first drive signal (Gate_Drive_1) may be transmitted from a first gate output of the DCR 108 to a gate of the first gate (Q1) via resistor R1. Similarly, the second drive signal (Gate_Drive_2) may be transmitted from a second gate output of the DCR 108 to a gate of the second gate (Q2) via resistor R2. In accordance with embodiments of the present system, the first drive signal will have a corresponding on time Ton1 and second drive signal will have a corresponding on time Ton2. When in a normal mode of operation (e.g., a mode other than the SCM), Ton1 and Ton2 may be set substantially equal to Ton for a corresponding cycle.

Thus, the current output (I_{LOAD}) of the half bridge 104 may be controlled by frequency control “HO” and “LO” inputs Q1 and Q2, respectively, by frequency as opposed to duty cycle which may be maintained at or (substantially at) fifty (50) percent. Further, a dead time allowance may be provided to prevent cross conduction through the gates of Q1 and Q2.

To determine Ton, the DCR 108 may periodically or non-periodically process feedback information such as that which may be provided by the FDBK signal IHB_av and adjust a Ton in accordance with a 50% duty cycle to the half bridge 104 so as to control a half bridge current I_{LOAD} during a corresponding cycle which, for example, may have a duration of, for example, 850 μS (which, for example, may be based upon a speed of a digital control loop of the controller 102 of the present system 100). However, it is envisioned that this cycle may have other durations. The value of Ton will not change during a corresponding cycle. However, at the end of the corresponding cycle (e.g., a current cycle), the DCR 108 may update the Ton value for the next cycle based on the measurements from the current cycle to correct and/or maintain is regulation of the half bridge current I_{LOAD} and, thus, power of the one or more lamps 106 while maintaining a 50 percent (or substantially 50 percent) duty cycle for the next cycle. Further, with respect to the half bridge current I_{LOAD}, this current may be transmitted to the load 116 via, for example, capacitor C1 and inductor L1 (the indictor L_{R}).

The DCR 108 may include a striation control portion (SC) 110 which may be configured to control striations in an output of the one or more lamps 106 so as to prevent, minimize, and/or eliminate the formation of striations output by the one or more lamps 106. When activated (e.g., when in the SCM or at other/all times, if desired), the SC 110 may control the DCR 108 to modulate (e.g., change) the first and second drive signals (e.g., Gate_Drive_1 and Gate_Drive_2, respectively) in accordance with a SCM technique of the present system to control an output of the half bridge (e.g., half bridge current I_{LOAD}) so as to prevent, reduce, and/or eliminate striations in the output of the one or more lamps 106. Accordingly, the SC 110 may modulate Ton1 and Ton2 by setting or changing their values in accordance with an SCM technique (e.g., calculation, pattern, etc.) so as to correspondingly modulate the first and second drive signals in light of a corresponding value of Ton (which the SC 110 may obtain when necessary) and so that the first and second drive signals Gate_Drive_1 and Gate_Drive_2, respectively, may be asymmetrically modulated during at least part of a corresponding cycle. Accordingly, unlike the normal mode of operation discussed above where Ton1 and Ton2 are set such that they are substantially equal to Ton, when in the SCM, Ton1 and Ton2 may be modulated (e.g., in accordance with a default of selected SCM technique) such that Ton1 and Ton2 may vary in accordance with a segment of a plurality of segments within a corresponding cycle. Further, with regard to segments, each i^{th} segment (e.g., segment (i)) of the plurality of segments may have duration (aka segment time such as 50 μsec. in the present example). Thus, for each corresponding cycle, there may be I segments where Total segments (I)=(cycle time)/(segment time). Thus, in the present example there may be 850/50=17 segments. However, other numbers of segments are also envisioned. During each of these I segments, the SC 110 may act to modulate Ton1 and Ton2 in accordance with a corresponding equation for the segment (i) and may modulate Ton1 and Ton2 for all segments of a corresponding cycle as will be described below.

FIG. 2 shows a flow diagram that illustrates a process 200 in accordance with embodiments of the present system. The process 200 may be performed using one or more computers communicating over a network. The process 200 may include one of more of the following acts. Further, one or more of these acts may be combined and/or separated into sub-acts, if desired. In operation, the process 200 may start during act 201 and then proceed to act 203.

During act 203, the process may drive a half-bridge circuit in accordance with a current Ton value for a cycle (e.g., 850 μs, etc., in the current example). The Ton value may correspond with, for example, a 50% duty cycle and may be generated in accordance with a feedback signal (e.g., IHB_av, etc.) so as to regulate a current output of the half bridge to a load so as to regulate lamp power. Assuming that the process is a mode other than the SCM, the process may set Ton1 and Ton2 equal to Ton and generate first and second drive signals in accordance with Ton1 and Ton2 respectively. Then, the process may drive the first and second gates (Q1 and Q2, respectively) with the first and second drive signals for a cycle. After completing act 203, the process may continue to act 205.

During act 205, the process may obtain one or more feedback signals during the cycle which are indicative of current supplied to the load such as the feedback signal IHB_av. After completing act 205, the process may continue to act 207. During act 207, the process may determine a Ton value for the next cycle. Accordingly, the process may analyze the feedback signal IHB_av and determine a corresponding Ton value to regulate the half bridge current (e.g., (I_{LOAD}) in accordance with a 50% duty cycle. After completing act 207, the process may continue to act 209.

During act 209, the process may determine whether to enable SCM. Accordingly, if it is determined to enable SCM, the process may continue to act 211. However, if it is determined not to enable SCM, the process may continue to act 223. The process may determine to enable SCM when, for example, it is determined that striations are present in an output of the lamp (e.g., image analysis of light output of the lamp, when certain operating settings are detected such as when operating in a certain dimming setting or range, temperature or temperature range (e.g., cold or below or above a certain temperature threshold, etc.), etc., and/or may be manually activated or be activated continuously (e.g., always on). For example, the process may use a table lookup to determine various operating conditions (e.g., temperatures, currents, etc.) and/or modes (e.g., start, cold, dimming, normal, steady state, fault, etc.) in which the SCM may be enabled. Each lookup table may be further associated with a certain lamp and/or ballast combination. Accordingly, the process may determine a lamp and/or ballast combination and obtain a corresponding lookup table from, for example, a memory of the system. Thus, as striations may not occur over an entire dimming range of a ballast, the process may determine to disable SCM in certain operating ranges or levels (e.g., diming ranges or levels, etc.) of the ballast which do not require striation control. In this way, generation of striations may be avoided over a range of settings (e.g., dimming ranges or levels). Further, the process may determine not to enable SCM when striations are detected in the output of the lamp and/or under certain settings. Moreover, sensor feedback such as lamp temperature, etc., may be used by the process to determine when to activate the SCM techniques and/or when to disable them. For example, the system may determine that based on certain dimming and lamp temperature that striations will be present (or may be expected to be present) and enable the striation control circuit accordingly. However, in yet other embodiments of the present system, it is envisioned that the SCM may be enabled at all times. Accordingly, the process may proceed from act 207 to 213, if desired.

During act 211, the process may select an SCM technique. The SCM technique may include a pattern, mathematical equation(s), etc., and may be selected in accordance with certain operating conditions (e.g., temperature or temperature ranges, output current, etc.), operating settings (e.g., dimming mode, energy savings mode, frequency, e.g., 200 Hz, modulation, etc.), etc., that are detected using any suitable method such as by analysis of sensor and/or feedback information related to operation of the ballast and/or lamp. For example, when it is detected that the ballast is operating in a dimming mode, a first SCM technique may be selected, while when it is detected that the lamp is cold, a different SCM technique may be selected. Accordingly, the process may obtain an SCM technique from, for example, a table lookup obtained from a memory of the system to determine a corresponding SCM technique to use. Further, it is also envisioned that the process may select a default SCM technique.

Further, the process may select a SCM technique based upon a desired output for a given lamp current envelope. For example, Tables 1 through 5 below, illustrate different SCM techniques which correspond with illustrative lamp current envelopes (e.g., 502, 602, 702, 802, and 902) shown in FIGS. 5 through 9, respectively, for the lamp (e.g., a fluorescent lamp) of FIG. 4 (which is a graph 400 illustrating a lamp current envelope 402 with anti-striation modulation disabled) and modulated in accordance with embodiments of the present system. Accordingly, the process may set a desired lamp current such as those shown in FIGS. 5 through 9 (e.g., 500, 600, 700, 800, and 900) which show illustrative experimental lamp current envelopes (e.g., 502, 602, 702, 802, and 902) obtained using SCM in accordance with embodiments of the present system. Each of Tables 1 through 5 illustrates a corresponding SCM technique to obtain the desired lamp currents illustratively shown in FIGS. 5 through 9. Thus, for example, if a lamp current envelope shown in FIG. 5 is desired, the process may select the SCM technique illustrated in Table 1 below. Similarly, if for example, a lamp current envelope shown in FIG. 6 is desired, the process may select the SCM technique illustrated in Table 2 below. SCM techniques may be unique to a ballast and/or lamp type and may be based upon experimental results, etc. The process may also select a default SCM technique, if desired.

TABLE 1

| Segment (i) | Ton1 | Ton2 |
|---|---|---|
| 1 | = Ton − (80*16 nS) | = Ton + (80*16 nS) |
| 2 | = Ton + (60*16 nS) | = Ton − (60*16 nS) |
| 3 | = Ton − (40*16 nS) | = Ton + (40*16 nS) |
| 4 | = Ton + (20*16 nS) | = Ton − (20*16 nS) |
| 5 | = Ton − (10*16 nS) | = Ton + (10*16 nS) |
| 6 | = Ton + (10*16 nS) | = Ton − (10*16 nS) |
| 7 | = Ton − (20*16 nS) | = Ton + (20*16 nS) |
| 8 | = Ton + (40*16 nS) | = Ton − (40*16 nS) |
| 9 | = Ton − (60*16 nS) | = Ton + (60*16 nS) |
| 10 | = Ton + (80*16 nS) | = Ton − (80*16 nS) |
| 11 | = Ton − (80*16 nS) | = Ton + (80*16 nS) |
| 12 | = Ton + (60*16 nS) | = Ton − (60*16 nS) |
| 13 | = Ton − (40*16 nS) | = Ton + (40*16 nS) |
| 14 | = Ton + (20*16 nS) | = Ton − (20*16 nS) |
| 15 | = Ton − (10*16 nS) | = Ton + (10*16 nS) |
| 16 | = Ton + (10*16 nS) | = Ton − (10*16 nS) |

With reference to Table 1, a plurality of segments (e.g., 16 50 μsec time segments(i)) are shown during which modulated signals Ton1 and Ton2 are calculated by the process as set forth for a corresponding segment (i). In accordance with embodiments of the present system, Ton1 refers to an on time of a first gate drive signal (e.g., Gate_drive_1) generated (e.g., by the DCR 108) and transmitted to the high gate (e.g., Q1) of the half-bridge. Ton2 refers to an on time of a second gate drive signal (e.g., Gate_drive_2) generated (e.g., by the DCR 108) and transmitted to the low gate (e.g., Q2) of the half-bridge. The modulated Ton1 and Ton2 may be referred to as Ton1′ and Ton2′, respectively. In accordance with embodiments of the present system, Ton for a given segment is generated based on feedback obtained from a previous cycle to regulate an output current of the half-bridge for the current cycle for example in accordance with a 50% duty cycle.

With reference to a number and/or duration of segments in Tables 1 through 5, the segments of these tables may be repeated (e.g., in numerical order starting from a first segment) to cover a time period of a corresponding cycle. Thus, with reference for example to Table 5, the first and second segments may be repeated in order a number of times until the cycle is complete. Further, if the cycle is complete between the first and last segments, the process may terminate the current cycle without finishing the last segment shown in a corresponding table of Tables 1 through 5 or other user or system configured tables which may also be suitably applied.

As Tables 2 through 5 are similar to Table 1, accordingly detailed descriptions thereof are not provided to simplify the discussion herein. As may be readily appreciated, Tables 1 through 5, illustrate different SCM techniques which may be applied to generate lamp current envelopes as shown although other segments of Ton1 and Ton2 may also be suitably applied in accordance with embodiments of the present system.

TABLE 2

| Segment (i) | Q1 Ton (TON1) | Q2 Ton (Ton2) |
|---|---|---|
| 1 | = Ton − (140*16 nS) | = Ton + (140*16 nS) |
| 2 | = Ton + (140*16 nS) | = Ton − (140*16 nS) |
| 3 | = Ton − (80*16 nS) | = Ton + (80*16 nS) |
| 4 | = Ton + (80*16 nS) | = Ton − (80*16 nS) |
| 5 | = Ton − (60*16 nS) | = Ton + (60*16 nS) |
| 6 | = Ton + (60*16 nS) | = Ton − (60*16 nS) |
| 7 | = Ton − (40*16 nS) | = Ton + (40*16 nS) |
| 8 | = Ton + (40*16 nS) | = Ton − (40*16 nS) |
| 9 | = Ton − (30*16 nS) | = Ton + (30*16 nS) |
| 10 | = Ton + (30*16 nS) | = Ton − (30*16 nS) |
| 11 | = Ton − (20*16 nS) | = Ton + (20*16 nS) |
| 12 | = Ton + (20*16 nS) | = Ton − (20*16 nS) |
| 13 | = Ton − (10*16 nS) | = Ton + (10*16 nS) |
| 14 | = Ton + (10*16 nS) | = Ton − (10*16 nS) |
| 15 | = Ton − (0*16 nS) | = Ton + (0*16 nS) |
| 16 | = Ton + (0*16 nS) | = Ton − (0*16 nS) |

TABLE 3

| Segment (i) | Q1 Ton | Q2 Ton |
|---|---|---|
| 1 | = Ton − (80*16 nS) | = Ton + (80*16 nS) |
| 2 | = Ton − (70*16 nS) | = Ton + (70*16 nS) |
| 3 | = Ton − (60*16 nS) | = Ton + (60*16 nS) |
| 4 | = Ton − (50*16 nS) | = Ton + (50*16 nS) |
| 5 | = Ton − (40*16 nS) | = Ton + (40*16 nS) |
| 6 | = Ton − (30*16 nS) | = Ton + (30*16 nS) |
| 7 | = Ton − (20*16 nS) | = Ton + (20*16 nS) |
| 8 | = Ton − (10*16 nS) | = Ton + (10*16 nS) |
| 9 | = Ton + (10*16 nS) | = Ton − (10*16 nS) |
| 10 | = Ton + (20*16 nS) | = Ton − (20*16 nS) |
| 11 | = Ton + (30*16 nS) | = Ton − (30*16 nS) |
| 12 | = Ton + (40*16 nS) | = Ton − (40*16 nS) |
| 13 | = Ton + (50*16 nS) | = Ton − (50*16 nS) |
| 14 | = Ton + (60*16 nS) | = Ton − (60*16 nS) |
| 15 | = Ton + (70*16 nS) | = Ton − (70*16 nS) |
| 16 | = Ton + (80*16. nS) | = Ton − (80*16 nS) |
| 17 | = Ton + (80*16 nS) | = Ton − (80*16 nS) |
| 18 | = Ton + (70*16 nS) | = Ton − (70*16 nS) |
| 19 | = Ton + (60*16 nS) | = Ton − (60*16 nS) |
| 20 | = Ton + (50*16 nS) | = Ton − (50*16 nS) |
| 21 | = Ton + (40*16 nS) | = Ton − (40*16 nS) |
| 22 | = Ton + (30*16 nS) | = Ton − (30*16 nS) |
| 23 | = Ton + (20*16 nS) | = Ton − (20*16 nS) |
| 24 | = Ton + (10*16 nS) | = Ton − (10*16 nS) |
| 25 | = Ton − (10*16 nS) | = Ton + (10*16 nS) |
| 26 | = Ton − (20*16 nS) | = Ton + (20*16 nS) |
| 27 | = Ton − (30*16 nS) | = Ton + (30*16 nS) |
| 28 | = Ton − (40*16 nS) | = Ton + (40*16 nS) |
| 29 | = Ton − (50*16 nS) | = Ton + (50*16 nS) |
| 30 | = Ton − (60*16 nS) | = Ton + (60*16 nS) |
| 31 | = Ton − (70*16 nS) | = Ton + (70*16 nS) |
| 32 | = Ton − (80*16 nS) | = Ton + (80*16 nS) |

TABLE 4

| Segment (i) | Q1 Ton | Q2 Ton |
|---|---|---|
| 1 | = Ton − (80*16 nS) | = Ton + (80*16 nS) |
| 2 | = Ton − (60*16 nS) | = Ton + (60*16 nS) |
| 3 | = Ton − (40*16 nS) | = Ton + (40*16 nS) |
| 4 | = Ton − (20*16 nS) | = Ton + (20*16 nS) |
| 5 | = Ton + (20*16 nS) | = Ton − (20*16 nS) |
| 6 | = Ton + (40*16 nS) | = Ton − (40*16 nS) |
| 7 | = Ton + (60*16 nS) | = Ton − (60*16 nS) |
| 8 | = Ton + (80*16 nS) | = Ton − (80*16 nS) |
| 9 | = Ton + (80*16 nS) | = Ton − (80*16 nS) |
| 10 | = Ton + (60*16 nS) | = Ton − (60*16 nS) |
| 11 | = Ton + (40*16 nS) | = Ton − (40*16 nS) |
| 12 | = Ton + (20*16 nS) | = Ton − (20*16 nS) |
| 13 | = Ton − (20*16 nS) | = Ton + (20*16 nS) |
| 14 | = Ton − (40*16 nS) | = Ton + (40*16 nS) |
| 15 | = Ton − (60*16 nS) | = Ton + (60*16 nS) |
| 16 | = Ton − (80*16 nS) | = Ton + (80*16 nS) |

TABLE 5

| Segment (i) | Q1 Ton | Q2 Ton |
|---|---|---|
| 1 | = Ton − (60*16 nS) | = Ton + (60*16 nS) |
| 2 | = Ton + (60*16 nS) | = Ton − (60*16 nS) |

With regard to the various SCM techniques such as those illustrated in Table 2, some segments may have symmetry (e.g., are symmetrical or have zero symmetry as opposed to being asymmetrical) such as segments 15 and 16 and may be mixed with a plurality of asymmetric segments, if desired. FIG. 3 is a screenshot of a graph 300 illustrating a pulse width modulation (PWM) output from a controller (e.g., controller 102) to a half bridge driver for generating the current envelope shown in FIG. 9 in accordance with experimental embodiments of the present system. A lamp current envelope 305 (C1) and waveform 306 (Z1) are shown (Z1 is a small expanded portion of the lamp current envelope C1) as well as a graph illustrating a transition of a PWM gate drive signal 307 (see also C2 and Z2) to a switch of the half bridge between first to second segments (e.g., segment (1) and segment (2)) in accordance with the SCM technique shown in Table 5 and resultant output of which is shown in FIG. 9. With regard to the lamp current 306, it may form a sinusoidal waveform for example as shown.

After completing act 211, the process may continue to act 213.

During act 213, the process may determine Ton1′ and Ton2′ for each corresponding segment in accordance with the selected SCM technique. Thus, for example, the process may obtain Ton and calculate Ton1′ and Ton2′ for each segment. As discussed above Ton1′ and Ton2′ are modulated in accordance with the selected SCM technique.

Regarding Tables 1 through 5, it is seen that through the asymmetrical modulation of the inputs to the half bridge circuit (e.g., inputs to Mosfets Q1, Q2) duty cycle, striation of the lamp may be effectively controlled. Specifically, in the illustrative embodiments shown in Tables 1 through 5, Ton1′ and Ton2′ may generally be set in accordance with Equation 1 for a plurality of segments (i) within the duration of the cycle:

Ton1′(i)=Ton+kx(i), and

Ton2′(i)=Ton−kx(i), Eq. (1)

wherein Ton is set to regulate a current supplied to the load in accordance with the 50% duty cycle, k is a constant and x(i) varies in accordance with each segment(i). X(i) may further be bounded so that it is greater than a first integer and less than a second integer or may be an integer having a value that is less than or equal to a threshold value (e.g., 40, etc.) and may be generated by, for example, a random number generator. With regard to k, this value may be an integer and may be used to multiply corresponding values of x(i), if desired. It is envisioned that a random number generator may be included to generate k in real time. However, values of k generated by, for example, the random number generator may be limited such that they are within bounds suitable for stable operation of embodiments of the present system. In other words, values of k may be limited to values which may maintain the functionality of an output stage of a ballast.

Further, with regard to x(i), this value may be determined, for example, in accordance with resolution (e.g., the smallest step time) of a pulse width modulation (PWM) waveform modulated to form the first and second gate drive signals (e.g., Gate_drive_1 and Gate_drive_2, respectively) formed by the DCR 108. Accordingly, the resolution may be dependent upon hardware used to form the PWM waveform. In accordance with embodiments of the present system, the resolution may illustratively be set to 16 ns, however, other values are also envisioned.

Further, in embodiments of the present system, a number of the segments and the duration of each segment may be interrelated and depend on each other. For example, in the embodiments shown in Tables 1 through 2 and 4, 16 segments having a 50 μs duration are used. However, other numbers of segments and/or duration of each segment are also envisioned. In accordance with embodiments of the present system, a number of segments and/or a duration of segments may be set/changed as a function of ballast output power (e.g., dimming).

After completing act 213, the process may continue to act 215. During act 215, the process may drive the high and low gates Q1 and Q2, respectively, in accordance with Ton1′ and Ton2′ (for each segment(i) or until the corresponding cycle ends) determined above for a current cycle (e.g., which starts at this act and last for the cycles duration e.g., 850 μsec. in the current example) Accordingly, the process may generate the first drive signal (e.g., Gate_drive_1) in accordance with Ton1′ and transmit this signal to the high gate (Q1); and generate the second drive signal (e.g., Gate_drive_2) in accordance with Ton2′ and transmit this signal to the low gate (Q2) of the half-bridge for each of the segments of the cycle. As discussed above, if all of the segments(i) are completed or determined to be complete before an end of the current cycle occurs, the process may repeat segments(i) (e.g., starting from the first segment) and generate corresponding first and second drive signals in accordance with the repeated segments until the current cycle ends. Thus, during act 215, the process may modulate the high and low switches Q1 and Q2 in accordance the selected SCM technique to reduce or eliminate striations in lamps driven by the half bridge. Thus, referring back to FIGS. 4 through 9, duty cycle modulation may be changed every 50 uS (e.g., at each segment which changes) during a cycle.

During act 217, the process may obtain feedback information (e.g., IHB_av) which may be used to regulate a load current (e.g., I_{LOAD}) of the half-bridge for a next cycle. In accordance with embodiments of the present system, the feedback information may be obtained once or several times over a period of time and averaged. After completing act 217, the process may continue to act 219.

During act 219, the process may determine Ton for the next cycle in accordance with the feedback information obtained during act 217. Accordingly, the process may analyzed the feedback information obtained during act 217 such as IHB_av and adjust Ton in accordance with a 50% duty cycle (e.g., to the half bridge) so as to control (e.g., regulate) a half bridge output current (I_{LOAD}) during the next cycle. After completing act 219, the process may continue to act 221.

During act 221, the process may determine whether the current cycle has ended. Accordingly, if it is determined that the current cycle has ended, the process may repeat act 209. However, if it is determined that the current cycle has not ended, the process may continue applying the segments during act 215 thereafter repeating act 221 until it is determined that the cycle ends. As may be readily appreciated by a person of ordinary skill in the art, acts 217 and 219 may not need be applied after each segment as depicted in the flow chart which is presented as shown to simplify the discussion herein and may in accordance with embodiments of the present system, be only applied one or more times for each cycle.

As discussed above, during act 209, if it is determined not to enable SCM, the process may continue to act 223. During act 223, the process may set Ton1 and Ton2 equal to Ton for the current cycle and continue to act 225. Thus, Ton1 and Ton2 are not modulated during the corresponding cycle.

During act 225, the process may begin a current cycle and drive the half bridge for the current cycle in accordance with Ton1 and Ton2. Thus, the process may drive the high and low gates (Q1) and (Q2), respectively, in accordance with Ton1 and Ton2 for the current cycle (e.g., of 850 μsec) and will not change Ton (for the current cycle) nor Ton1 or Ton2 during this time. Accordingly, the process may generate the first drive signal (e.g., Gate_drive_1) in accordance with Ton1 and transmit this signal to the high gate (Q1); and generate the second iii drive signal (e.g., Gate_drive_2) in accordance with Ton2 and transmit this signal to the low gate (Q2) of the half-bridge for the current cycle. Unlike act 215, during act 225 the first and second gate drive signals are formed in accordance with Ton and do not change substantially during the current cycle. After starting act 225, the process may continue to act 217 and continue thereafter as discussed above. Referring back to FIG. 4, this figure illustrates a baseline (lamp) current envelope 402 and shows notches (STs) having a duration STT and an amplitude STA due to a filament heating circuit being turned on and off. Note the current envelope appears to have a (sinusoidal) standing wave pattern as illustrated by (dot-dashed) line 403 and which may be pierced by the notches STs. The standing wave pattern also appears on the bottom portion of the current envelope. The striation control (e.g., anti-striation) methods of the present system may change the lamp current envelop so as to reduce or entirely prevent striations in the lamp (c.f., FIGS. 5 through 9, and FIG. 4). Thus, in accordance with embodiments of the present system, modulation of a drive signal (e.g., a gate drive signal) to a corresponding gate of a half-bridge circuit thereby modulating the output current envelope of a lamp driven by the half bridge circuit and thereby, reduce or substantially eliminate the lamp striations produced as a result. In accordance with embodiments of the present system, this operation may be considered a frequency dimming method of striation control. Further, with regard to the notches ST which are shown in FIGS. 4 through 9, these notches may be removed by, for example, disabling (e.g., turning off, etc.) the filament heating circuit.

FIG. 10 shows a portion of a system 1000 (e.g., including a controller 102, etc.) in accordance with embodiments of the present system. For example, a portion of the present system may include a processor 1010 operationally coupled to a memory 1020, one or more sensors 1060, a half bridge 1050, and a user input portion 1070. The sensors 1060 may include any suitable sensors such as voltage, current, temperature, and/or image sensors (e.g., of an analog to digital (AD) type, etc.) which may provide sensor information which may be analyzed by the system. The memory 1020 may be any type of device (i.e., transitory and/or non-transitory) for storing application data as well as other data related to the described operation. The application data and other data are received by the processor 1010 for configuring (e.g., programming) the processor 1010 to perform operation acts in accordance with the present system. The processor 1010 so configured becomes a special purpose machine particularly suited for performing in accordance with the present system. The processor 1010 may be coupled to a half bridge 1050 and may generate signals to drive the half-bridge 1050 so as to deliver power to a load 1040 which may include at least one lamp and may include a resonant circuit.

The operation acts may include controlling operation of a load such as one or more lamps. The user input portion 1070 may include a light switch, keyboard, mouse, trackball or other device for controlling operation of the lamp. The user input portion 1070 may be operable for interacting with the processor 1010 including enabling interaction within a UI as described herein, such as to select an SCM technique. In embodiments of the present, clearly the processor 1010 may operate to control the SCM technique without user intervention, such as selecting a technique suited for striation control for a cold lamp in response to one or more sensors detecting suitable operating conditions. Clearly the processor 1010, the memory 1020, and/or user input device 1070 may all or partly be a portion of a computer system or other device as described herein.

The methods of the present system are particularly suited to be carried out by a computer software program, such program containing modules corresponding to one or more of the individual steps or acts described and/or envisioned by the present system. Such program may of course be embodied in a computer-readable medium, such as an integrated chip, a peripheral device or memory, such as the memory 1020 or other memory coupled to the processor 1010.

The program and/or program portions contained in the memory 1020 configure the processor 1010 to implement the methods, operational acts, and functions disclosed herein. The memories may be distributed or local and the processor 1010, where additional processors may be provided, may also be distributed or may be singular. The memories may be implemented as electrical, magnetic or optical memory, or any combination of these or other types of storage devices. Moreover, the term “memory” should be construed broadly enough to encompass any information able to be read from or written to an address in an addressable space accessible by the processor 1010. With this definition, information accessible through a network is still within the memory, for instance, because the processor 1010 may retrieve the information from the network for operation in accordance with the present system.

The processor 1010 is operable for providing control signals and/or performing operations in response to input signals from the user input portion 1070, the sensors 1060, as well as in response to other devices of a network and executing instructions stored in the memory 1020. The processor 1010 may be an application-specific or general-use integrated circuit(s). Further, the processor 1010 may be a dedicated processor for performing in accordance with the present system or may be a general-purpose processor wherein only one of many functions operates for performing in accordance with the present system. The processor 1010 may operate utilizing a program portion, multiple program segments, and/or may be a hardware device utilizing a dedicated or multi-purpose integrated circuit.

It is envisioned that embodiments of the present system may be embedded on one or more chips such as an integrated circuit (IC) chip so as to form for example, a ballast control IC. Moreover, it is envisioned that embodiments of the present system may be compatible with analog-controlled ballasts. For example, a modulation circuit may be added to change the duty cycle of the half bridge in the same fashion as the digital version so as to control striations in an output of one or more lamps driven by the analog-controlled ballast.

Further, it is envisioned that the present system may be operative with dimmable and/or non-dimmable fluorescent ballasts. Embodiments of the present system may interface with standard as well as energy savings fluorescent lamps or the like and/or lighting systems including these lamps.

Thus, by slightly changing a duty cycle of the half bridge 104 (e.g., by changing a duty cycle of the first and second gates), striations can be minimized or eliminated in the lamps 106. Accordingly, the DCR 108 may control striations in the one or more lamps 106 during one or more operating modes such as steady-state mode, a normal mode, a dimming mode, a fault mode, etc., and during various operating conditions (e.g., temperature ranges (e.g., cold, warm, over temperature) each of which may have one or more corresponding anti-striation techniques, patterns, and/or settings assigned thereto. In accordance with embodiments of the present system, the DCR 108 may control striations in a plurality of lamps which each may be controlled using the same or a different SCM technique.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or an preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts or steps is intended to be required unless specifically indicated; and

i) the term “plurality of” an element includes two or more of the claimed element, and does not imply any particular range of number of elements; that is, a plurality of elements may be as few as two elements, and may include an immeasurable number of elements.

What is claimed is:

1. An apparatus to supply power to at least one gas lamp, the apparatus comprising a half bridge driver having a striation control circuit which:
determines an on time (Ton) for a cycle in accordance with a fifty percent duty cycle, the cycle having a plurality of segments and lasting for a predetermined period of time; and
modulates on times Ton1 and Ton2 of first and second power switches, respectively, of a half-bridge circuit in accordance with a striation control technique while maintaining the fifty percent duty cycle for Ton1 and Ton2 for each of the plurality of segments.

2. The apparatus of claim′, wherein the striation control circuit modulates Ton1 and Ton2 differently from each other within a given segment of each of the plurality of segments within the cycle while maintaining the fifty percent duty cycle for Ton1 and Ton2.

3. The apparatus of claim 1, wherein the striation control circuit modulates Ton1 and Ton2 in accordance with a predetermined striation control pattern of the striation control technique.

4. The apparatus of claim 3, wherein the striation control circuit sets Ton1 and Ton2 in accordance with the following equations for a plurality of segments (i) within the cycle:
Ton1(i)=Ton+kx(i), and
Ton2(i)=Ton−kx(i),
wherein Ton is set to regulate a current supplied to the load in accordance with the fifty percent duty cycle, k is a constant, and x(i) varies in accordance with each segment (i).

5. The apparatus of claim 1, wherein the striation control circuit determines whether a last segment (i) of the plurality of segments has been completed and repeats one or more of the plurality of segments starting from the first segment of the plurality of segments until it is determined that the cycle is completed.

6. The apparatus of claim 1, wherein the striation control circuit:
determines whether striations are present in an output of the at least one gas lamp;
modulates Ton1 and Ton2 of first and second power switches, respectively, of a half-bridge circuit in accordance with the striation control technique for each of the plurality of segments, when it is determined that striations are present in the output of the at least one gas lamp; and
sets Ton1 and Ton2 equal to each other and to Ton when it is determined that striations are not present in an output of the at least one gas lamp.

7. The apparatus of claim 6, wherein the striation control circuit determines that striations are present in an output of the at least one gas lamp based upon one or more of a dimming setting and a temperature of the at least one lamp.

8. A method to control a switching half-bridge circuit to supply power to a load, the method comprising one or more acts which are performed by a processor, the acts comprising:
determining an on time (Ton) for a cycle in accordance with a fifty percent duty cycle, the cycle having a plurality of segments and lasting for a predetermined period of time; and
modulating on times Ton1 and Ton2 of first and second power switches, respectively, of a half-bridge circuit in accordance with a striation control technique while maintaining the fifty percent duty cycle for Ton1 and Ton2 for each of the plurality of segments.

9. The method of claim 8, further comprising an act of modulating Ton1 and Ton2 differently from each other within a given segment and to Ton for a plurality of segments within the cycle while maintaining the fifty percent duty cycle for Ton1 and Ton2.

10. The method of claim 8, further comprising an act of modulating Ton1 and Ton2 in accordance with a predetermined striation control pattern.

11. The method of claim 10, further comprising an act of setting Ton1 and Ton2 in accordance with the following equations for a plurality of segments (i) within the cycle:
Ton1(i)=Ton+kx(i), and
Ton2(i)=Ton−kx(i),
wherein Ton is set to regulate a current supplied to the load in accordance with the fifty percent duty cycle, k is a constant, and x(i) varies in accordance with each segment (i).

12. The method of claim 8, further comprising acts of:
determining whether a last segment (I) of the plurality of segments has been completed; and
repeating one or more of the plurality of segments starting from the first segment of the plurality of segments until it is determined that the cycle is completed.

13. The method of claim 8, further comprising acts of:
determining whether to operate in a striation control mode (SCM); and
setting Ton1 and Ton2 in accordance with a striation control setting when it is determined to operate in the SCM.

14. The method of claim 8, further comprising acts of:
determining whether striations are present in an output of the load;
modulating Ton1 and Ton2 of first and second power switches, respectively, of a half-bridge circuit in accordance with the striation control technique for each of the plurality of segments, when it is determined that striations are present in the output of the load; and
sets Ton1 and Ton2 equal to each other and to Ton when it is determined that striations are not present in the output of the load.

15. The method of claim 8 wherein it is determined that striations are present in an output of the at least one gas lamp based upon one or more of a dimming setting and a temperature of the at least one gas lamp.

16. A computer program stored on a computer readable non-transitory memory medium, the computer program configured to supply power to at least one gas lamp, the computer program comprising:
a program portion configured to:
determine an on time (Ton) for a cycle in accordance with a fifty percent duty cycle, the cycle having a plurality of segments and lasting for a predetermined period of time;
modulate on times Ton1 and Ton2 of first and second power switches, respectively, of a half-bridge circuit in accordance with a striation control technique while maintaining the fifty percent duty cycle for Ton1 and Ton2 for each of the plurality of segments; and
generate first and second control signals for driving the first and second power switches, respectively, in accordance with Ton1 and Ton2, respectively.

17. The computer program of claim 16, wherein the program portion is further configured to modulate Ton1 and Ton2 differently from each other within a given segment and to Ton for a plurality of segments within the cycle while maintaining the fifty percent duty cycle for Ton1 and Ton2.

18. The computer program of claim 16, wherein the program portion is further configured to modulate Ton1 and Ton2 in accordance with a predetermined striation control pattern.

19. The computer program of claim 16, wherein the program portion is further configured to set Ton1 and Ton2 in accordance with the following equations for a plurality of segments (i) within the cycle:
Ton1(i)=Ton+kx(i), and
Ton2(i)=Ton−kx(i),
wherein Ton is set to regulate a current supplied to the load in accordance with the fifty percent duty cycle, k is a constant, and x(i) varies in accordance with each segment (i).

20. A ballast for providing power to a fluorescent lamp, the ballast comprising:
a half bridge circuit having first and second switches in series with each other and an output for providing power to the fluorescent lamp;
a power supply circuit to regulate a direct current (DC) voltage supplied to an input of the half bridge;
a regulator configured to determine an on time (Ton) corresponding with a fifty percent duty cycle for a cycle having a plurality of segments and a modulating value M(i) for each of the plurality of segments (i) and to generate a first signal to drive the first switch with a first on time (Ton1) and a second signal to drive the second switch with a second on time (Ton2) such that Ton1=Ton+M(i) and Ton2=Ton−M(i) for each of the plurality of segments of the cycle while maintaining the fifty percent duty cycle Ton1 and Ton2.
